(19) United States
(12) Patent Application Publication
(10) Pub. No.: US 2013/0118917 A1
(43) Pub. Date: May 16, 2013

(54) BATHING WATER, METHOD FOR THE PRODUCTION AND SYSTEM COMPRISING A BATHING OR SWIMMING POOL

(71) Applicants: Robert HERMANN, Oberaich (AT); Michael SCHELCH, Oberaich (AT); Wolfgang STABER, Bruck an der Mur (AT); Wolfgang WESNER, Wien (AT)

(72) Inventors: Robert HERMANN, Oberaich (AT); Michael SCHELCH, Oberaich (AT); Wolfgang STABER, Bruck an der Mur (AT); Wolfgang WESNER, Wien (AT)

(21) Appl. No.: 13/675,250

(22) Filed: Nov. 13, 2012

(30) Foreign Application Priority Data
Nov. 15, 2011 (AT) A 1691/2011

(51) Int. Cl. C02F 1/461

(52) U.S. Cl. CPC C02F 1/46104
USPC 205/742; 204/240

(57) ABSTRACT

The invention relates to bathing water on the basis of tap water, which is suitable for treatment by means of electrolysis. The bathing water contains at least one of the alkali metal ions Na⁺, K⁺ or Li³⁰ in a content of 100 mg/l up to the saturation limit and the chloride (Cl⁻) content of which is that of the underlying tap water.

The invention relates to bathing water on the basis of tap water, which is suitable for treatment by means of electrolysis. The invention further relates to a method for producing bathing water and to a system comprising a bathing or swimming pool.

It is common to chlorinate the water in bathing or swimming pools for disinfection, because chlorine, in a very low concentration of a few tenths of milligrams per liter, already kills germs, which are present in the water. To date, no real alternative exists for disinfecting bathing water with chlorine. Organic pollutants in the water are oxidized by chlorine and are thus decomposed, wherein between 0.3 mg and 0.6 mg of free chlorine for each liter of water are permitted for each liter of bathing water in public pools. It is permissible to briefly increase the concentration only to prevent epidemics. In clean water, chlorine as reaction partner finds only the organic substances of bacteria, which are killed. In water comprising organic contamination, the chlorine also binds to pollutants and forms organochlorinated compounds therewith. The so-called chloramines are created by combining chlorine with nitrogen compounds, which stem from urine or sweat, for example. Chlorine-nitrogen compounds are combined under the term “bound chlorine”. The typical smell in swimming pools and the occurrence of irritations of the eye can be ascribed to chloramines. A low value of bound chlorine is thus a criterion for a good water quality.

Chlorine-carbon compounds, in particular trihalogenmethanes (THM), which are highly volatile organic halogen compounds, furthermore form in the water. There is a reasonable suspicion of a carcinogenic effect for trihalogenmethanes, of which chloroform (tritlamethane) is the most commonly known representative. A reference value for the THM pollution, below which a carcinogenic effect is to not be expected, does not exist at this time, but is to be developed. As long as damages to human health cannot be excluded, these as well as other suspicious substances in the bathing water must be considered to be dangerous to health for reasons of precaution and the concentration thereof must be limited accordingly.

The invention is thus based on the object of providing bathing water, which can be treated electrolytically, which does not require chlorine for disinfection, which does not require a pH-regulation and which does not contain or create any compounds, which are dangerous to health.

The posed object is solved according to the invention in that bathing water contains at least one of the alkali metal ions Na⁺, K⁺ or Li⁺ in a content of 100 mg/l up to the saturation limit and the chloride (Cl⁻) content of which is that of the underlying tap water.

The alkali metal ions contained in the water ensure the electrical conductivity, which is required for the electrolysis. The disinfecting agents for removing the organic contaminations are created directly from the water by means of electrolysis. These ions increase the electrical conductivity of the water and buffer the pH-value to a value of 8 or higher, thus in an optimal range, which does not dry out the skin, but which regulates the acid-base balance.

The method according to the invention for producing bathing water, which can be treated by means of electrolysis and which is based on tap water, is characterized in that at least one of the hydrogen carbonate compounds NaHCo₃, KHCO₃ or LiHCO₃ and/or one of the carbonate compounds Na₂Co₃, K₂CO₃ or Li₂CO₃ is added in such a quantity that the conductivity of the water is at least 0.5 mS/cm. The bathing water according to the invention is produced once in response to or directly after filling the bathing or swimming pool, respectively, and remains in optimum quality for a very long period of time for the entire swimming season almost without any maintenance effort. Salt, from which active chlorine substances (Cl₂, HClO, ClO⁻) could develop, is not added to the water. The water is adjusted to a conductivity value of at least 0.5 mS/cm by means of one or a plurality of the mentioned hydrogen carbonate compounds or carbonate compounds. Once adjusted, conductivity and hardness change, for example in response to refilling or in response to water loss. Due to the composition of the bathing water, a pH-value in a magnitude of 8 is adjusted, depending on the quantity of the added compounds, in particular up to 11, which is an optimal range for the human skin. It is thus also not necessary to add pH-regulators. It is not even necessary to check the pH-value during the swimming season or the pool operation, respectively.

For an optimal function of the electrolysis of the water and for a good skin tolerance, the tap water is first softened, wherein a total hardness of ≦7° dH, in particular ≦4° dH, preferably ≦3° dH is adjusted.

In the bathing water according to the invention, the alkali metal ions stem from one or a plurality of compounds NaHCo₃, KHCO₃, LiHCO₃, Na₂Co₃, K₂CO₃ or Li₂CO₃, which are added.

The bathing water according to the invention encompasses a total hardness of ≦7° dH. In particular, the total hardness thereof is ≦4° dH, preferably ≦3° dH. A low total hardness of the bathing water is advantageous for an efficient and low-maintenance function of the electrolysis cell, which is provided for the electrolysis.

The electrical conductivity of the bathing water according to the invention is mainly a function of the content of alkali metal ions Na⁺, K⁺ and Li⁺ and should be at least 0.5 mS/cm, in particular up to 10 mS/cm, preferably up to 5 mS/cm.

It is possible to add the hydrogen carbonate compounds and/or the carbonate compounds to the bathing water in a quantity, until the respective saturation limit has been reached. A dosing at the saturation limit is advisable in particular for specific pools in smaller bathing pools, which are not provided for swimming.

The mentioned softening of the water can be carried out in a simple manner by means of reverse osmosis or by means of ion exchange.

The invention further relates to a system comprising a bathing or swimming pool and a treatment loop comprising a filtering device, a circulating device and an electrolysis cell, which is installed into the bypass or into the main flow. The system is initially filled with bathing water, which contains at least one of the alkali metal Na⁺, K⁺ and Li⁺ in a content of 100 mg/l up to the saturation limit, wherein the conductivity of the water is at least 0.5 mS/cm. For creating the oxidizing or disinfecting agents, respectively, the bathing water is used in the operation of the system by electrolysis in the electrolysis cell. Electrolysis cells, which contain either platinum-, iridium-, iridium/ruthenium or diamond electrodes, are particularly well suited.

Further features, advantages and details of the invention follow from the following description.

The invention deals with the water treatment or disinfection of bathing water, respectively, in particular in swimming pools, artificially constructed bathing ponds, bathing pools and the like in the private and commercial sector. The water treatment according to the invention is based on the activation of oxygen in the bathing water by means of electrolysis of the bathing water in an electrolysis cell. Peroxide and alkali percarbonate, which act as carriers (storage) of active oxygen, are created at the anode of the electrolysis unit in addition to electrolysis oxygen. It is possible in this manner to obtain a depot effect for active oxygen in the entire pool.

The bathing water itself is thus an electrolyte, which is based on tap water, in particular the water from the communal water supply. The bathing water according to the invention encompasses a hardness of ≦7° dH (degree of German hardness), in particular ≦4° dH and preferably ≦3° dH, and a content of at least one of the alkali metal ions Na⁺, K⁺ and Li⁺ between 100 mg/l and the saturation limit, preferably between 500 mg/l and 5000 mg/l. The conductivity of the bathing water has a value of between 0.5 mS/cm and that conductivity value, which is adjusted when the saturation limit has been reached. Water in swimming pools is adjusted in particular to a conductivity of up to 10 mS/cm, preferably of up to 5 mS/cm. A preferred value for the conductivity lies at 2.5 mS/cm. The content of Cr ions in the bathing water is very low, results only from the natural content of Cl⁻ ions in the used tap water, which is typically between 1 mg/l and 40 mg/l. Due to the low hardness, the bathing water further has only a small content of Ca²⁺ and Mg²⁺ ions.

The content of the alkali metal ions Na⁺, K⁺ and Li⁺ is reached by adding one or a plurality of the hydrogen carbonate compounds NaHCO₃, KHCO₃ or LiHCO₃ and/or one or a plurality of the carbonate compounds Na₂Co₃, K₂CO₃ or Li₂CO₃. The addition of NaHCO₃, if necessary together with Na₂CO₃ is preferred, wherein the ratio of these two compounds depends on which pH-value is to be adjusted in the bathing water. Depending on the quantity of NaHCO₃ in water, a pure solution of NaHCO₃ results in a pH-value of between 7.6 and 8.2, a pure solution of Na₂CO₃ results in a pH-value of up to 11. The adjustment of the total hardness takes place prior to the addition of these compounds by separating the hardness components, preferably in the known manner by means of reverse osmosis or ion exchange. In response to filling the basin or pool, the tap water can thus be softened in a reverse osmosis system or in an ion exchange system (water decalcification system), for example.

After filling the bathing pool or swimming pool, respectively, with softened water, one or a plurality of the mentioned hydrogen carbonate or carbonate compounds is or are added, respectively, in such a quantity until the electrical conductivity of the water assumes a certain value, which was chosen ahead of time, in the range of 0.5 mS/cm to the value when reaching the saturation limit. As already mentioned, this range in the case of water in swimming pools is preferably between 0.5 and 10 mS/cm, for example 2.5 mS/cm.

Optionally, the electrical conductivity can partly be adjusted by adding NaCl. Between 10% and 40% of the electrical conductivity can thereby stem from added NaCl.

To create the disinfecting agents from the electrolyte, the bathing water, by means of electrolysis, the bathing water is guided through an electrolysis cell. The electrolysis cell can be set up in a manner, which is known per se, the electrodes thereof consist in particular of iridium, iridium/ruthenium, platinum or are diamond electrodes (such as, e.g., electrodes of doped diamond particles). The electrolysis cell can include one or a plurality of bipolar electrodes of the mentioned materials. The electrolysis cell is installed in particular into the pump-operated cycle for the water treatment into the bypass or also into the main flow, respectively, at a location downstream from the mechanical filtering in a filtering device, for example a sand filter. In the case of a bathing pool, which contains approximately 100 m³ of water, approximately 1200 liters of water are guided through the electrolysis cell per hour in the bypass, for example during the operation of the water treatment, when the pump is running.

In the alternative, the electrolysis cell can also be embodied as immersion cell, for example according to the Austrian patent No. 509286 and can be positioned directly in the basin, in the case of smaller bathing pools, in the case of whirlpools or hot tubs.

The active oxygen compounds sodium percarbonate, sodium hydrogen percarbonate, potassium percarbonate, potassium hydrogen percarbonate, lithium percarbonate, lithium hydrogen carbonate and hydrogen peroxide are created by means of the electrolysis of the bathing water as a function of the composition of the bathing water as disinfecting agents, so that the bathing water is treated optimally. Particles, which fall into the bathing water, are removed mechanically by means of the filtering device. In contrast to the biological treatment systems, it is sufficient when the treatment cycle operates for approx. eight hours per day. Due to the composition of the bathing water, a pH-value of between approximately 8 and approximately 11, which remains, is adjusted “automatically”. It is no longer necessary to test the pH-value of the bathing water during the swimming season and a regulating addition of chemicals to increase the pH or to lower the pH, as it is required in response to the disinfection with chlorine, is thus also not necessary anymore.

In the event that it is necessary to refill fresh water or in the event that larger quantities of rain have reached the bathing or swimming pool, it is suggested to check the conductivity, so as to add a hydrogen carbonate or a carbonate compound, if necessary, so as to reestablish the desired conductivity.

Swimming or bathing water, respectively, according to the invention also does not develop a chlorine smell and the enrichment of organochlorinated compositions is no longer necessary. A water change is not required and steel corrosion must not be expected due to the very low chloride content and the lack of oxidation agent based on chlorine as well as a pH-value of >8 (see Pourbaix diagram for iron). Due to a pH-value in the range of approximately 8 to approximately 11, the bathing or swimming water, respectively, is furthermore downright skin-friendly.

The bathing water according to the invention encompasses an excellent compatibility with different bath additives. Additives, which cannot be used for the most part in chlorinated bathing water, because chlorinated compounds, which are harmful to health and the environment, would consequently be created, can be used without any danger in the bathing water according to the invention. This considerably broadens the application possibilities of the invention. To fulfill customer needs, which go beyond the pure functionality, different additives can be added to the bathing water. These additives can serve to increase the skin-friendliness or the well-being of the visitors, such as oils, proteins, organic acids, in particular fatty acids and the derivates thereof, sulfonic acids, alcohols, multiple alcohols, such as glycerin and the derivates thereof, emulsions of oils, plants and fruit extracts, further magnesium-, iron-, manganese and molybdenum salts, as well as salts of other trace elements, but also additives, which simply change the perception of the bathing water in an optical (color, transparency, optical brighteners, lighting effects) or olfactory (smell and taste) manner. In addition, the characteristic (consistency) of the water can be modified by means of additives, for example by means of starch derivates, algae extracts or emulsions. Other additives to the bathing water according to the invention can have specific effects. Examples with regard to this are foaming agents, fizz or substances, which influence the subjective perception of the temperature of the bathing water. Under the conditions, as they prevail on the basis of the oxidative treatment, all of these additives do not need to have a long-term stability. The additives fulfill their function for a certain amount of time and are supplemented, if necessary.

1. Bathing water on the basis of tap water, which is suitable for treatment by means of electrolysis,
characterized in
that it contains at least one of the alkali metal ions Na⁺, K⁺ or Li⁺ in a content of 100 mg/l up to the saturation limit and the chloride (Cl⁻) content of which is that of the underlying tap water.

2. The bathing water according to claim 1, characterized in that the alkali metal ions stem from one or a plurality of the compounds NaHCO₃, KHCO₃, LiHCO₃, Na₂CO₃, K₂CO₃ or Li₂CO₃, which are added to the bathing water.

3. The bathing water according to claim 1, characterized in that it encompasses a total hardness of ≦7° dH, in particular ≦4° dH, preferably ≦3° dH.

4. The bathing water according to claim 1, characterized in that it encompasses an electrical conductivity of between 0.5 mS/cm and 10 mS/cm, in particular up to 5 mS/cm, and preferably in the magnitude of 2.5 mS/cm.

5. The bathing water according to claim 1, characterized in that oxidizing or disinfecting agents, respectively, are created from the bathing water by means of electrolysis in an electrolysis cell.

6. The bathing water according to claim 1, characterized in that it additionally contains one or a plurality of the substances oils, proteins, organic acids, in particular fatty acids and the derivates thereof, sulfonic acids, alcohols, multiple alcohols, such as glycerin and the derivates thereof, emulsions of oils, plants and fruit extracts, further magnesium-, iron-, manganese and molybdenum salts, as well as salts of other trace elements, or additives, which change the perception of the bathing water in an optical or olfactory manner or additives, which modify the state (consistency) of the water, for example starch derivates, algae extracts or emulsions, further foaming agents, fizz or substances, which influence the subjective perception of the temperature of the bathing water.

7. A method for producing bathing water on the basis of tap water, which is suitable for treatment by means of electrolysis,
characterized in
that at least one of the hydrogen carbonate compounds NaHCO₃, KHCO₃ or LiHCO₃ and/or one of the carbonate compounds Na₂CO₃, K₂CO₃ or Li₂CO₃ is added in such a quantity that the conductivity of the water is at least 0.5 mS/cm.

8. The method according to claim 7, characterized in that the hydrogen carbonate compound(s) and/or carbonate compound(s) is or are added, respectively, up to the saturation limit.

9. The method according to claim 7, characterized in that the hardness components in the tap water are separated ahead of time, for example by means of reverse osmosis or ion exchange, up to a total hardness of ≦7° dH, wherein the total hardness of the tap water is adjusted in particular to ≦4° dH, preferably ≦3° dH.

10. The method according to claim 7, characterized in that the conductivity of the water is adjusted to a value of between 0.5 mS/cm and 10 mS/cm, in particular up to 5 mS/cm, preferably to a value in the magnitude of 2.5 mS/cm.

11. The method according to claim 10, characterized in that between 10% and 40% of the electrical conductivity is adjusted by adding NaCl.

12. The method according to claim 7, characterized in that one or a plurality of the substances oils, proteins, organic acids, in particular fatty acids and the derivates thereof, sulfonic acids, alcohols, multiple alcohols, such as glycerin and the derivates thereof, emulsions of oils, plants and fruit extracts, further magnesium-, iron-, manganese and molybdenum salts, as well as salts of other trace elements, or additives, which change the perception of the bathing water in an optical or olfactory manner or additives, which modify the state (consistency) of the water, for example starch derivates, algae extracts or emulsions, further foaming agents, fizz or substances, which influence the subjective perception of the temperature of the bathing water, are additionally added to the bathing water.

13. Bathing water on the basis of tap water, which is suitable for treatment by means of electrolysis,
characterized in
that the bathing water contains at least one of the alkali metal ions Na⁺, K⁺ or Li⁺ in a content of 100 mg/l up to the saturation limit, wherein the conductivity of the water is at least 0.5 mS/cm.

14. A system comprising a bathing or swimming pool and a treatment cycle comprising a filtering device, a circulating device and an electrolysis cell, which is installed into the bypass or into the main flow,
characterized in
that the system is initially filled with bathing water, which contains at least one of the alkali metal ions Na⁺, K⁺ and Li⁺ in a content of 100 mg/l up to the saturation limit, wherein the conductivity of the water is at least 0.5 mS/cm.

15. The system according to claim 14, characterized in that the electrolysis cell contains platinum-, iridium-, iridium/ruthenium or diamond electrodes.
